(19) United States
(12) Patent Application Publication
(10) Pub. No.: US 2004/0039599 A1
(43) Pub. Date: Feb. 26, 2004

(54) Method of distributing cost savings to participants in a prescription drug distribution chain

(76) Inventor: Donald R. Fralic, Monroeville, PA (US)

Correspondence Address: Webb Ziesenheim Logsdon Orkin & Hanson, P.C., Suite 700, 436 Seventh Avenue, Pittsburgh, PA, 15219, US

(21) Appl. No.: 10/121,472

(22) Filed: Apr. 11, 2002

Related U.S. Application Data
(60) Provisional application No. 60/283,000, filed on Apr. 11, 2001.

(51) Int. Cl. G06F 17/60

(52) U.S. Cl. 705/2

(57) ABSTRACT

A method of prescription drug cost savings distribution includes enrolling participants at different levels of a prescription drug distribution and payment chain in a plan for distributing cost savings realized from the selection of a generic form of a prescription drug over a brand name form thereof. If it is determined that a patient participant received a generic form of a prescription drug, a cost difference between the generic form of the prescription drug versus the brand name form of the prescription drug is determined. A percentage of the cost difference is then allocated to one or more of the enrolled participants.

### CROSS REFERENCE TO RELATED APPLICATION

This application claims priority from U.S. Provisional Patent Application Serial No. 60/283,000, filed Apr. 11, 2001.

### BACKGROUND OF THE INVENTION

1. Field of the Invention

The present invention is directed to a method for inducing prescription drug using patients to use generic forms of prescription drugs over corresponding formulary equivalent brand name prescription drug.

2. Description of Related Art

Heretofore, there has been little or no financial incentive for an insured patient to request the prescription of a generic drug by their physician, especially patients who have all or part of their insurance premiums paid by a third party.

It is therefore an object of the present invention to overcome the above problem and others by providing a method for inducing patients to request prescription of a generic drug versus a brand name drug. Still other objects of the invention will become apparent to those of ordinary skill in the art upon reading and understanding the following detailed description.

### SUMMARY OF THE INVENTION

Accordingly, I have invented a method of distributing savings related to the distribution of a prescription drug. The method includes identifying participants of a plan that participate in the distribution of a prescription drug or the payment for said distribution to one of said participants. A determination is made that the said one participant acquired a first form of a prescription drug for which a second, more costly form exists. A cost difference between the first and second forms of this prescription drug are determined and this cost difference is allocated to at least two of the participants.

The one participant includes a patient. The other participants can include an entity insuring the patient for all or part of the cost of the prescription drug, a physician prescribing the prescription drug to the patient, a pharmaceutical entity which causes the prescription drug to be dispensed to the patient, a pharmaceutical benefits managing entity and/or a method facilitating entity.

The method can further include distributing to at least one participant the cost difference allocated thereto. This distribution can include distributing to the patient the cost difference allocated to the patient and/or distributing to a third party entity designated by the physician the cost difference allotted to the physician.

The cost difference distributed to the patient can be in the form of a credit to be applied toward the acquisition of additional quantities of the same or another prescription drug.

The method can further include distributing to at least one of the pharmaceutical entity, the benefits managing entity and the method facilitating entity the cost difference allotted thereto.

Preferably, each participant is allotted a predetermined percentage of the cost difference, where each predetermined percentage is either the same or different than any of the other predetermined percentages.

I have also invented a method of distributing cost savings realized from the distribution of a prescription drug. The method includes enrolling participants at different levels of a prescription drug distribution and payment chain in a plan for distributing cost savings realized from the selection of a generic form of a prescription drug over a brand name form of the prescription drug. Next, a determination is made that a patient participant received a generic form of a prescription drug for which a brand name form exists. A cost difference is determined between the generic and brand name forms of the prescription drug and a percentage of the cost difference is allocated to one or more of the enrolled participants.

The cost difference is allocated to one or more non-patient participants based on each said non-patient participant participating in the patient participant receiving the generic form of the prescription drug and/or a payment related to the patient participant receiving the generic form of the prescription drug.

The method can also include distributing to at least one enrolled participant the cost difference allotted to said participant.

Lastly, I have invented a method of prescription drug cost savings distribution. The method includes enrolling in a plan for distributing cost savings realized from selecting a generic form of a prescription drug over a brand name form of the prescription drug. The generic form of the prescription drug is then selected and at least a portion of a difference between the cost of the generic form of the prescription drug and the cost of the brand name form of the prescription drug is received.

The portion of the difference can be received in the form of cash, a check, or a credit.

The method can also include distributing plural portions of the cost difference to enrollees of the plan based on each enrollee participating in the receipt of the generic form of the prescription drug and/or a payment related to the receipt of the first form of the prescription drug.

### BRIEF DESCRIPTION OF THE DRAWINGS

FIG. 1 is a block diagram of participants of a plan for sharing the cost difference between generic and brand name pharmaceuticals communicatively connected together via a computer network;

FIG. 2 is a graph of percent allocation of cost savings having superimposed thereon an inverse Laffer Curve of group prescription cost; and

FIG. 3 is a flow diagram of a method for sharing the cost difference between generic and brand name pharmaceuticals in accordance with the present invention.

### DETAILED DESCRIPTION OF THE INVENTION

The present invention will now be described with reference to the accompanying Figs. As used herein, the phrases generic form of a prescription drug, generic drug, generic prescription drug and the like are intended to include not only a generic drug that is formulary equivalent to a brand name drug but also to an alternative drug that has a lower cost than the brand name drug. Accordingly, the phrases generic drug, generic prescription drug, generic form of a prescription drug and the like are intended to convey the concept of one form of a prescription drug that is less costly then another form of a formulary equivalent prescription drug.

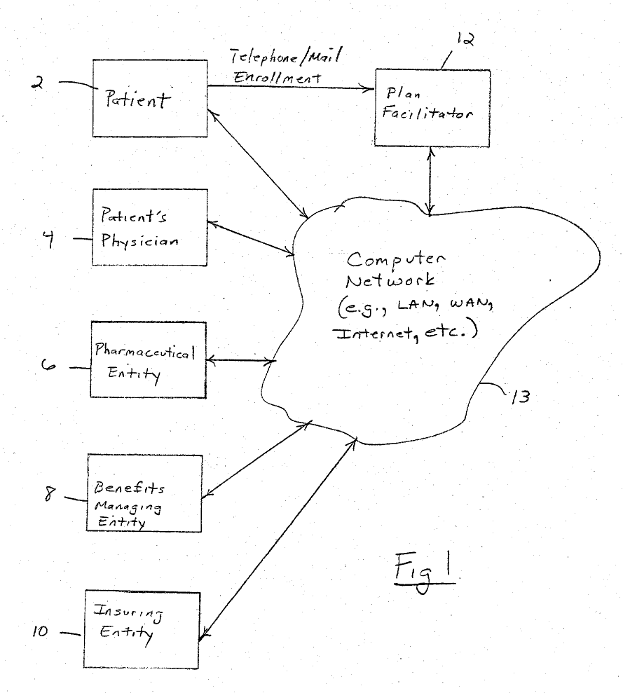

With reference to FIG. 1, in connection with the distribution of a prescription drug to an insured patient 2 by a pharmaceutical entity 6 based on a prescription ordered for patient 2 by physician 4, there is often one or more other entities that participate in the distribution and/or have a financial interest in the distribution. One such entity includes an insuring entity 10 that may be contractually obligated to pay all or part of the costs of the prescription drug dispensed to patient 2. Another entity may include a benefits managing entity 8 that works with pharmaceutical entity 6 on behalf of insuring entity 10. For example, at a point of sale of the prescription drug to patient 2, pharmaceutical entity 6 contacts benefits managing entity 8 to ensure that patient 2 has active insurance coverage, the extent to which this insurance coverage covers the cost of the prescription drug being dispensed to patient 2 and any applicable discounts for the prescription drug negotiated between pharmaceutical entity 6 and insuring entity 10. Based on this information, benefits managing entity 8 authorizes reimbursement to pharmaceutical entity 6 on behalf of insuring entity 10 for insured cost of the prescription drug being dispensed to patient 2. Pharmaceutical entity 6 then charges patient 2 any difference between this insured cost and the point of sale cost to patient 2. Absent benefits managing entity 8, pharmaceutical entity 6 obtains this information directly from insuring entity 10.

The present invention will now be described with reference to entities 2-10 being enrolled in a plan which is administered by a plan facilitator 12. However, other participants, such as drug companies, Internet sites, and the like that participate in the dispensing of the prescription drug and/or have a financial interest in the dispensing of the prescription drug may also be plan participants. For purpose of illustration, exemplary cost savings realized by the dispensing of a generic prescription drug over a brand name, formulary equivalent prescription drug will be described. In addition, a percent allocation and distribution of the savings in accordance with the present invention will also be described by way of example. However, these examples are not to be construed as limiting as the invention in any manner.

Initially, participants 2-10 at different levels of a prescription drug distribution and payment chain are enrolled in a plan for distributing cost savings realized from the dispensing of a generic form of a prescription drug over a brand name form of the prescription drug. Preferably, physician 4, pharmaceutical entity 6, and insuring entity 10 are initially enrolled in the plan. If a benefits managing entity 8 is utilized by insuring entity 10, benefits managing entity 8 is also enrolled as a participant in the plan. Thereafter, patient 2 can be enrolled in the plan at a suitable time. However, this order of enrollment is not to be construed as limiting the invention.

Since an order or prescription for a prescription drug originates with physician 4, physician 4 controls whether patient 2 is prescribed a generic drug versus a brand name drug. To this end, when prescribing a prescription drug for patient 2, if physician 4 believes a generic drug will work as effectively as a brand name drug, physician 4 either unilaterally writes the prescription for a generic drug or can consult with patient 2 as to the patient's 2 preference for a generic drug versus a brand name drug. This consultation may include physician 4 advising patient 2 that they can participate in any cost savings realized by insuring entity 10 in response to patient 2 agreeing to permit physician 4 to prescribe, and physician 4 prescribing, a generic drug versus a formulary equivalent brand name drug.

As a result of prescribing a generic drug over a brand name drug, insuring entity 10 allocates a percentage of any cost savings realized by insuring entity 10 as a result of this selection to patient 2 and physician 4. Since physician 4 is often precluded from accepting compensation for prescribing certain prescription drugs, when the time comes to pay the percentage of the cost savings allocated to physician 4, this percentage is paid to a designee, e.g., a medical institution or charity, of the doctor's choosing.

To facilitate patient 2 joining the plan, brochures and other like information can be provided to physician 4 for distribution to patient 2. These brochures and other like information can be provided by insuring entity 10 or any other entity, such as a generic drug company, that stands to profit from patient 2 receiving a generic drug versus a comparable brand name drug.

If patient 2 elects to participate in the plan, patient 2, and other plan participants, preferably enroll in the plan with plan facilitator 12 via a computer network 13, such as the Internet. However, this is not to be construed as limiting the invention since participants can enroll in the plan telephonically and/or by mail. Once enrolled in the plan, computer network 13 is utilized by the plan participants to facilitate the plan. However, this is not to be construed as limiting the invention since the plan participants can also or alternatively facilitate the plan telephonically and/or by mail. For example, patient 2 can enroll in the plan with plan facilitator 12 via computer network 13, by calling a telephone number hosted by plan facilitator 12, by mailing a registration form to plan facilitator 12 or by some combination thereof. To encourage patients to enroll via computer network 13, the brochures or other like materials promoting the plan can explain that patient 2 can receive a larger share of realized cost savings by registering via computer network 13, e.g., online via an Internet Webpage, versus registering via telephone or by mail.

At any time during the patient's participation in the plan, patient 2 can elect to receive his percentage of the cost savings realized by insuring entity 10 in the form of a check, an insurance premium reduction, a defined benefit credit and/or a donation to a designated charity of the patient's choosing.

Once patient 2 has completed his enrollment, insuring entity 10, or benefits managing entity 8 on behalf of insuring entity 10, verifies the insurance data of patient 2 and patient registration is confirmed via computer network 13 and/or by written notice. Thereafter, patient 2 would be eligible to receive a percentage of the cost savings realized by insuring entity 10 when patient 2 is dispensed a generic drug over a brand name drug that is more costly than the generic drug.

Insuring entity 10 participates in the plan by completing a registration agreement with plan facilitator 12. The registration agreement contractually obligates insuring entity 10 to pay predetermined percentages of the realized cost saving between a generic drug and a comparable brand name drug directly to a selected designee of physician 4, patient 2, plan facilitator 12, pharmaceutical entity 6 and/or benefits managing entity 8.

The incentive for insuring entity 10 to participate in the plan is the economic benefit that flows to insuring entity 10 when a patient is dispensed a generic drug over a more costly brand name drug. Specifically, insuring entities generally receive sufficient funds to pay all or most of the cost of prescription drugs from insurance premiums received from patients and/or third parties on behalf of patients, e.g., employers. If insuring entity 10 pays less for a prescription because a generic drug with identical therapeutic properties to an available brand name drug is prescribed by physician 4, either unilaterally or at the request of patient 2, insuring entity 10 will have excess funds available to it as a result of this selection.

These excess funds can be used to increase profits of the insuring entity and/or reduce overall insurance premiums. However, in accordance with the present invention, a significant financial incentive is provided to patient 2 when insuring entity 10 shares the cost savings by allocating and distributing to patient 2 a percentage of the savings in the form a check, premium reduction, benefit credit and/or donation to patient's 2 selected charity. The percentage of the cost savings allocated to patient 2 must be sufficient to encourage patient 2 to enter the plan since most patients would not be motivated to benefit insuring entity 10 unless patient 2 receives a benefit as well. The present invention enables significant financial benefits to be realized by patient 2 by sharing cost savings realized by insuring entity 10 when patient 2 is dispensed a generic drug versus a brand name drug.

In addition to patient 2, physician 4, insuring entity 10 and plan facilitator 12, additional participants in the plan can include pharmaceutical entity 6 and benefits managing entity 8. Specifically, often times, prescriptions are written in a manner whereupon a pharmacist of pharmaceutical entity 6 dispensing the prescription has the option of substituting a generic drug for a brand name drug if patient 2 consents to the substitution. To encourage pharmaceutical entity 6 to promote the use of generic drugs, pharmaceutical entity 6 can also be allotted and distributed a portion of the cost savings realized by insuring entity 10 from the dispensing of a generic drug over a brand name drug. To be eligible to receive the portion of the cost savings, pharmaceutical entity 6 enrolls in the plan with plan facilitator 12 whereupon pharmaceutical entity 6 agrees to promote the plan to its customers. This promotion by pharmaceutical entity 6 can either be passive promotion, e.g., signs, brochures, etc., or active promotion, e.g., where the pharmacist advises the patient of the plan.

Benefits managing entity 8 can also participate in the plan by agreeing to promote the plan with pharmaceutical entities 6 with whom it does business. To this end, once enrolled in the plan, benefits managing entity 8 can receive a portion of the cost savings realized by insuring entity 10 when patient 2 is dispensed a generic drug over a brand name drug.

For the purpose of distributing the percentages of the cost savings appropriately, a computer (not shown) of plan facilitator 12 can be programmed to record which participants 2-10 enrolled in the plan participated in the dispensing of a generic drug to patient 2 and/or payment for said dispensing. For example, in one exemplary transaction, physician 4 prescribes a generic drug to be dispensed to patient 2 by pharmaceutical entity 6. When patient 2 arrives at pharmaceutical entity 6 to receive his prescription, pharmaceutical entity 6 confirms with insuring entity 10 that pharmaceutical entity 6 will receive all or an agreed upon portion of the cost of pharmaceutical entity 6 dispensing the generic drug to patient 2. Thereafter, pharmaceutical entity 6 dispenses the generic drug to patient 2 after receiving any required co-payment from patient 2. In this transaction, the participants included patient 2, physician 4, pharmaceutical entity 6 and insuring entity 10. Data regarding the participants in this transaction can be provided to plan facilitator 12 by any one of participants 2, 4, 6 or 10. However, it is envisioned that pharmaceutical entity 6 will provide data regarding participants in this transaction to plan facilitator 12 since pharmaceutical entity 6 typically creates a complete record of the transaction including the identity of patient 2, the identity of physician 4 and the identity of insuring entity 10 that makes payments to pharmaceutical entity 6 on behalf of patient 2. To this end, it is envisioned that a computer or computer system of pharmaceutical entity 6 can be programmed to interface with a computer or computer system of insuring entity 10 and plan facilitator 12 via computer network 13 so that data regarding each eligible transaction under the plan is available to insuring entity 10 and plan facilitator 12.

In another exemplary transaction, physician 4 prescribes a generic drug to be dispensed to patient 2 by pharmaceutical entity 6. When patient 2 arrives at pharmaceutical entity 6 to receive this prescription, pharmaceutical entity 6 confirms with benefits managing entity 8 that pharmaceutical entity 6 will receive all or an agreed portion of the cost of pharmaceutical entity 6 dispensing the generic drug to patient 2 from insuring entity 10. Thereafter, pharmaceutical entity 6 dispenses the generic drug to patient 2 after receiving any required co-payment from patient 2. In this transaction, the participants included patient 2, physician 4, pharmaceutical entity 6, benefits managing entity 8 and insuring entity 10. Data regarding the participants in this transaction is provided to plan facilitator 12 by any one of participants 2-10, e.g., pharmaceutical entity 6.

Plan facilitator 12 organizes the plan among the participants and facilitates the plan's operations. For example, plan facilitator 12 preferably manages an Internet Website used for online registration and manages the exchange of forms with patients not registering via the Internet Website. Plan facilitator 12 can also develop or have developed the software that facilitates the plan as well as manage the software once implemented. Plan facilitator 12 can further manage the distribution of cost savings realized by insuring entity 10 to other participants in the plan. To this end, it is envisioned that whenever a generic drug is dispensed over a brand name drug, insuring entity 10 will withdraw its percent allocation from the cost savings and forward the reminder to plan facilitator 12 for distribution. After receipt of these funds, plan facilitator 12 withholds its percent allocation of the cost savings, and, at an appropriate time, distributes the reminder to other qualified participants.

The following table shows an exemplary allocation of costs savings realized by insuring entity 10 when patient 2 is dispensed a generic drug over a brand name drug.

| Participant | Allocation of Cost Savings |
|---|---|
| Patient | 40% to 45% |
| Physician | 2% |
| Pharmaceutical Entity | 1% |
| Benefits Managing Entity | 1% |
| Insuring Entity | 43% |
| Plan Facilitator | 9% to 13% |

The participants and/or Allocation of Cost Savings shown in the foregoing table are for the purpose of illustration and are not to be construed as limiting the invention.

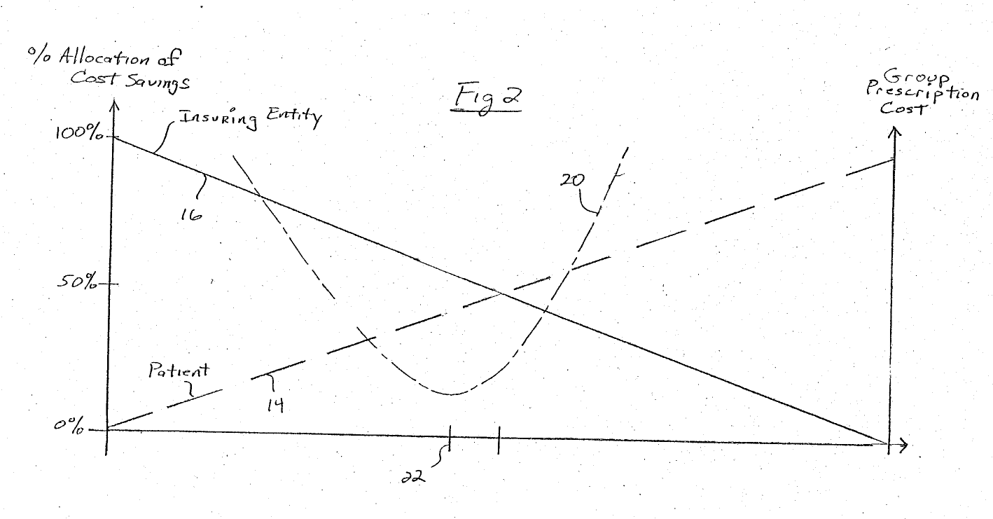

With reference to FIG. 2, it can be theoretically determined by application of an inverse Laffer Curve to a percent allocation of cost savings between insuring entity 10 and patient 2 where the allocation of cost savings will result in the lowest group prescription cost. For example, in FIG. 2, patient curve 14 and insuring entity curve 16 illustrate the relationship of percent allocation of cost savings between patient 2 and insuring entity 10. Specifically, increasing the percent allocation of cost savings to patient 2 from 0 to 100% results in a decrease in the percent allocation of cost savings to insuring entity from 100% to 0%. Utilizing economic theories underlying the Laffer Curve for determining the percent tax rate that will result in a maximum tax revenue, the inverse Laffer Curve 20 shown in FIG. 2 can be plotted for group prescription cost to determine where the optimum mix or lowest group cost 22 as a function of percent allocation between insuring entity 10 and patient 2 occurs. In FIG. 2, the slope of curves 14 and 16 and the position of inverse Laffer Curve 20 can be adjusted based on percentages of the cost savings being allocated to other participants of the plan.

In practice, curves 14, 16 and 20 are determined from empirical data acquired from the percent of cost savings allocated to insuring entity 10 and patient 2 at various points along the horizontal axis. The empirical data from these test simulations can then be utilized to empirically determine the shape and location of the inverse Laffer Curve 20. The graphs shown in FIG. 2 are for purpose of illustration only and are not to be construed as limiting the invention.

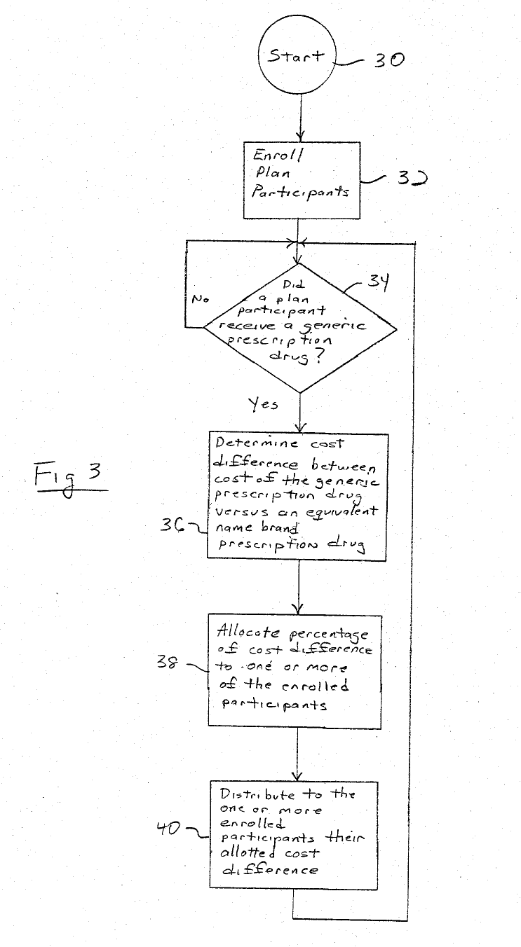

With reference to FIG. 3, the basic steps of the plan will now be described. Initially, when a decision is made to initiate the plan, the plan is advanced from step 30 to step 32 where plan participants enroll in the plan. Thereafter, the plan advances to step 34 where a determination is made whether a plan participant received a generic prescription drug. If not, the plan loops on this step 34 until a plan participant receives a generic prescription drug. However, if a plan participant receives a generic prescription drug, the plan advances to step 36. In step 36, a cost difference between the cost of the generic drug versus an equivalent brand name drug is determined. In step 38, various percentages of this cost difference are allocated to two or more of the enrolled participants. Preferably, each participant receiving a percentage of the cost difference participates in the dispensing of the generic drug and/or has a financial interest in the distribution of the generic drug versus an equivalent brand name drug. However, this is not to be construed as limiting the invention. Lastly, in step 40, the allotted cost difference is distributed to one or more enrolled participants or their designees. Steps 34-40 are then repeated as necessary for each plan participant receiving a generic prescription drug.

In FIG. 3, plan participants can be enrolled at anytime. Moreover, in the event there is no cost difference determined in step 36, no allocation or distribution of this cost difference in steps 38 and 40 is made.

As can be seen, the present invention provides a method for inducing patients to request the prescription of generic drugs versus brand name drugs by enabling the patient to share in any cost savings realized by the insuring entity from the selection.

The invention has been described with reference to the preferred embodiment. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A method of distributing savings related to the distribution of a prescription drug, the method comprising the steps of:
(a) identifying participants of a plan that participate in the distribution of a prescription drug or the payment for said distribution to one of said participants;
(b) determining that the said one participant acquired a first form of a prescription drug for which a second, more costly form exists;
(c) determining a cost difference between the first and second forms of the prescription drug; and
(d) allotting the cost difference to at least two of the participants.

2. The method as set forth in claim 1, wherein:
said one participant includes a patient; and
said participants further include an entity insuring the patient for all or part of the cost of the prescription drug and at least one of the following:
a physician prescribing the prescription drug to the patient;
a pharmaceutical entity which causes the prescription drug to be dispensed to the patient;
a pharmaceutical benefits managing entity; and
a method facilitating entity.

3. The method as set forth in claim 1, further including the step of distributing to one or more participants the cost difference allotted thereto.

4. The method as set forth in claim 2, further including the steps of:
distributing to the patient the cost difference allotted to the patient; and
distributing to an entity designated by the physician the cost difference allotted to the physician.

5. The method as set forth in claim 4, wherein the cost difference is distributed to the patient in the form of a credit, cash, or a check.

6. The method as set forth in claim 4, further including the step of distributing to at least one of the pharmaceutical entity, the pharmaceutical benefits managing entity and the method facilitating entity the cost difference allotted thereto.

7. The method as set forth in claim 6, wherein in step (d) each participant is allotted a predetermined percentage of the cost difference.

8. The method as set forth in claim 7, wherein each predetermined percentage is one of the same and different than any of the other predetermined percentages.

9. The method as set forth in claim 1, wherein the first and second forms of the prescription drug are a generic form and a brand name form, respectively.

10. A method of distributing cost savings realized from the distribution of a prescription drug, the method comprising the steps of:
(a) enrolling participants at different levels of a prescription drug distribution and payment chain in a plan for distributing cost savings realized from the selection of a first form of a prescription drug over a second, more costly form of the prescription drug;
(b) determining that a patient participant received the first form of the prescription drug;
(c) determining a cost difference between the first and second forms of the prescription drug; and
(d) allocating a percentage of the cost difference to at least one of the enrolled participants.

11. The method as set forth in claim 10, wherein the cost difference is allocated to one or more non-patient participants based on each said non-patient participant at least one of participating in the patient participant receiving the first form of the prescription drug and participating in a payment for the patient participant receiving the first form of the prescription drug.

12. The method as set forth in claim 10, wherein said participants further include an insuring entity participant that insures the patient for all or part of the cost of the prescription drug and at least one of the following:
a physician participant that prescribes the prescription drug to the patient;
a pharmaceutical entity participant that causes the prescription drug to be supplied to the patient;
a pharmaceutical benefits managing entity participant that controls payment by the insuring entity to the pharmaceutical entity participant that causes the prescription drug to be dispensed to the patient; and
a method facilitating entity participant that performs at least one of steps (a)-(d).

13. The method as set forth in claim 10, further including the step of distributing to at least one enrolled participant the cost difference allocated to said participant.

14. The method as set forth in claim 13, wherein the allocated cost difference is distributed to at least one of the following:
the patient participant;
a physician participant that prescribes the prescription drug to the patient;
a pharmaceutical entity participant that causes the prescription drug to be supplied to the patient;
a pharmaceutical benefits managing entity participant that controls payment by the insuring entity to the pharmaceutical entity participant that causes the prescription drug to be dispensed to the patient; and
a method facilitating entity participant that performs at least one of steps (a)-(d).

15. The method as set forth in claim 10, wherein the first and second forms of the prescription drug are a generic form and a brand name form, respectively.

16. A method of prescription drug cost savings distribution, the method comprising the steps of:
(a) enrolling in a plan for distributing cost savings realized from the selection of a first form of a prescription drug over a second form of the prescription drug that is more costly but formulary equivalent to the first form of the prescription drug;
(b) selecting the first form of the prescription drug; and
(c) receiving at least a portion of a difference between the cost of the first form of the prescription drug and the cost of the second form of the prescription drug.

17. The method as set forth in claim 16, further including the step of determining the difference between the cost of the first form of the prescription drug and the cost of the second form of the prescription drug.

18. The method as set forth in claim 16, wherein the portion of the difference is received in the form of at least one of cash, a check or a credit.

19. The method as set forth in claim 16, further including the step of distributing plural portions of the cost difference to enrollees of the plan based on each enrollee at least one of participating in the receipt of the first form of the prescription drug and participating in a payment related to the receipt of the first form of the prescription drug.
